(19) United States
(12) Patent Application Publication
(10) Pub. No.: US 2016/0040653 A1
(43) Pub. Date: Feb. 11, 2016

(54) INERTIAL CONTROL METHOD OF WIND TURBINE

(71) Applicant: INDUSTRIAL COOPERATION FOUNDATION CHONBUK NATIONAL UNIVERSITY, Jeonju-si (KR)

(72) Inventors: Yong Cheol KANG, Jeonju-si (KR); Jinsik LEE, Jeonju-si (KR); Jinho KIM, Jeonju-si (KR)

(21) Appl. No.: 14/588,960

(22) Filed: Jan. 4, 2015

(30) Foreign Application Priority Data
Aug. 5, 2014 (KR) 10-2014-0100386

(51) Int. Cl. F03D 9/00; F03D 7/00

(52) U.S. Cl. CPC F03D 9/003; F03D 7/00

(57) ABSTRACT

An inertial control method of a wind turbine includes the steps of: acquiring frequency information of a power grid; calculating a time variant droop coefficient when the frequency information is reduced below a preset range; and controlling the wind turbine using the calculated time variant droop coefficient, wherein the step of calculating a time variant droop coefficient includes the steps of: collecting rotor speed information changing according to the inertial control; and calculating the time variant droop coefficient using the collected rotor speed information.

### BACKGROUND OF THE INVENTION

1. Field of the Invention

The present invention relates to a method of controlling a wind turbine, and more specifically, to a control method of a wind turbine for promptly increasing effective power in order to contribute to control of frequency when a disturbance such as tripping of a synchronous generator occurs in a power grid.

2. Background of the Related Art

If a large disturbance such as tripping of a generator or increase of load occurs in a power grid, frequency of the power grid is reduced since electrical energy is insufficient. In Korea, if frequency becomes 59 Hz, an Under Frequency Load Shedding (UFLS) relay operates and sheds load by 6% to prevent consecutive tripping of generators and additionally rejects the load by 6% at every 0.2 Hz reduction of frequency. Accordingly, a lowest frequency of the power grid after the disturbance occurs is an important criterion for determining reliability of the power grid, and frequency of the power grid should not be less than 59 Hz to prevent load shedding.

Currently, variable speed wind turbines mainly used for generating wind power perform Maximum Power Point Tracking (MPPT) control to control the speed of a rotor in order to generate maximum output power according to wind speed. Since the MPPT control is performed regardless of change of frequency of a power grid, inertia of the power grid decreases in the power grid with high wind penetration. Therefore, since frequency reduction increases when a disturbance occurs in the power grid, a frequency control capability of a wind turbine is required to prevent severe frequency reduction.

A lot of methods for a wind turbine to contribute to frequency recovery of a power grid have been proposed. A method of adding a reference value generated by a loop for calculating a rate of change of frequency (ROCOF) of the power grid to a reference value of an output power of a wind turbine for performing the MPPT control has been proposed. This method may contribute to suppressing frequency reduction of the power grid by temporarily releasing the energy stored in the rotor of the wind turbine after a disturbance occurs, and although contribution to the recovery of frequency is high since the rate of change of frequency has a large value immediately after a disturbance occurs, contribution to the recovery of frequency is lowered since this value gradually decreases as time passes.

In most cases, the amount of power released by an inertial response and droop control of a synchronous machine in operation is larger than the capacity of tripped generators after a disturbance occurs. Therefore, the frequency rebounds after the reduction, and the sign of the rate of change of frequency becomes negative. Accordingly, although this method contributes to the recovery of frequency until the frequency rebounds, output power of a wind power plant is decreased after the frequency rebounds due to the inverted sign of the rate of change of frequency, and thus contribution to the recovery of frequency is lowered as a result.

A method of adding a loop for controlling deviation of frequency, which contributes to control of frequency by multiplying the deviation of frequency by a droop coefficient, to an existing control loop has been developed to solve the problem, and a method of calculating a droop coefficient of each wind turbine in a wind power plant has been proposed in the patent documents (Korean Patent Nos. 10-1318124 and 10-1398400, which are prior patents registered by the inventors of the present invention). In the patent document (Korean Patent No. 10-1318124), an individual droop coefficient is calculated based on kinetic energy of a wind turbine calculated at the starting point of inertial control, and in the patent document (Korean Patent No. 10-1398400), inertial control of a wind turbine is performed to calculate a droop coefficient based on a rate of change of frequency and update the droop coefficient in real-time.

On the other hand, when a wind turbine performs the inertial control such as the patent documents, the rotor speed of the wind turbine will be reduced due to the releasement of the kinetic energy. If the inertial control is performed without any consideration of an inertial control capability of the wind turbine, the rotor speed reaches the minimum operating speed. Then, the wind turbine should stop the inertial control and return to the MPPT control in order to increase the rotor speed. In this case, the significant power reduction from the wind turbine is inevitable and it will cause another disturbance to a power grid. Particularly in a power grid with high wind penetration, the power reduction can be bigger, thereby causing the second frequency dip.

### SUMMARY OF THE INVENTION

Therefore, the present invention has been made in view of the above problems, and it is an object of the present invention to provide a large amount of power to a power grid in order to rapidly recover frequency when a disturbance occurs.

In addition, an object of the present invention is to prevent the second frequency dip of a power grid by performing inertial control reflecting a limit of inertial control capability of each wind turbine.

Particularly, an object of the present invention is to propose a new method of calculating an inertial control coefficient, which is an improvement of a conventional method of calculating a droop coefficient using kinetic energy of a wind turbine calculated at the starting point of inertial control.

To accomplish the above objects, according to one aspect of the present invention, there is provided an inertial control method of a wind turbine, the method including the steps of: acquiring frequency information of a power grid; calculating the frequency deviation; calculating a time variant droop coefficient when the frequency information is reduced below a preset range; creating the output reference by multiplying the frequency deviation and the calculated time variant droop coefficient; (and controlling the wind turbine using the created output reference, and the step of calculating a time variant droop coefficient includes the steps of: collecting rotor speed information changing according to the inertial control in real-time; and calculating the time variant droop coefficient using the collected rotor speed information.

An example of calculating a time variant droop coefficient may include the steps of: calculating kinetic energy of a rotor using the rotor speed information; and calculating the time variant droop coefficient by comparing the calculated kinetic energy and maximum kinetic energy of the rotor. At this point, the time variant droop coefficient may be derived so that the kinetic energy of the rotor and energy released from the wind turbine may have a positive correlation.

Meanwhile, a lower limit of the time variant droop coefficient is assigned to the WG operating in the highest rotor speed may be determined by a wind power plant operator in order to set as the reference droop coefficient, and the step of calculating kinetic energy may be performed according to ΔEᵢ(t)=½J(ωᵢ(t)²−ωₘᵢₙ²), where ωᵢ(t) is rotor speed information according to time, ωₘᵢₙ is a minimum operating speed of a wind turbine, and J is a momentum of inertia.

In an embodiment of the present invention, the step of calculating the time variant droop coefficient may be performed according to

$${R}_{i} ( t ) = {R}_{0} \frac{Δ \overline{{E}_{max}}}{Δ \overline{{E}_{i} ( t )}} ,$$

where ΔEₘₐₓ is maximum kinetic energy, R₀ is a droop coefficient at the maximum kinetic energy, and ΔEᵢ(t) is kinetic energy according to time.

According to another aspect of the present invention, there is provided an inertial control method of a wind turbine, the method including, after the step of acquiring frequency information of a power grid, the steps of: collecting rotor speed information changing according to the inertial control in real-time; and calculating a time variant control coefficient proportional to the rotor speed by reflecting a driving range of the wind turbine, and the wind turbine control step includes controlling the wind turbine using the calculated time variant droop coefficient and the time variant control coefficient.

According to another aspect of the present invention, there is provided an inertial control method of a wind turbine, the method including, after the step of acquiring frequency information of a power grid, the steps of: calculating a rate of change of frequency; deriving the maximum value of the rate of change of frequency; and creating an output reference value by multiplying the derived maximum value of the rate of change of frequency and the time variant control coefficient, and the wind turbine control step may include controlling the wind turbine using the calculated time variant droop coefficient and time variant control coefficient while the maximum value of the rate of change of frequency is maintained.

To accomplish the above object, according to another aspect of the present invention, there is provided an inertial control method of a wind turbine, the method including the steps of acquiring frequency information of a power grid, collecting rotor speed information changing according to inertial control in real-time; and calculating a time variant control coefficient proportional to the rotor speed by reflecting a driving range of the wind turbine, and further including, after the step of acquiring frequency information of a power grid, the steps of: calculating a rate of change of frequency; deriving a maximum value of the rate of change of frequency; and creating an output reference value by multiplying the derived maximum value of the rate of change of frequency and the time variant control coefficient, and the wind turbine may be controlled according to the created output reference value.

### BRIEF DESCRIPTION OF THE DRAWINGS

FIG. 1 is a sequence diagram illustrating an inertial control method of a wind turbine according to an embodiment of the present invention.

FIG. 2 is a control loop showing an inertial control method of a wind turbine according to an embodiment of the present invention.

FIG. 3 is a mimetic view showing a model of a wind power plant for simulating an embodiment of the present invention.

FIGS. 4 to 8 are graphs showing results of simulations according to embodiments of the prior art and the present invention.

### DETAILED DESCRIPTION OF THE PREFERRED EMBODIMENT

Details of the objects and technical configuration of the present invention described above and operational effects according thereto will be clearly understood hereinafter by the detailed description with reference to the accompanying drawings attached in the specification of the present invention.

Meanwhile, the term “wind turbine” used in the present invention is a concept including one or a plurality of wind turbines. That is, control of a plurality of wind turbines is also expressed as control of a wind turbine. However, when a plurality of wind turbine is controlled, the expression of controlling a wind power plant is not separately distinguished from the expression of controlling a wind turbine. The inertial control method of the present invention is applied to control a wind turbine and a wind power plant without limit, and its scope is not limited.

Hereinafter, the present invention will be described in detail with reference to the accompanying drawings.

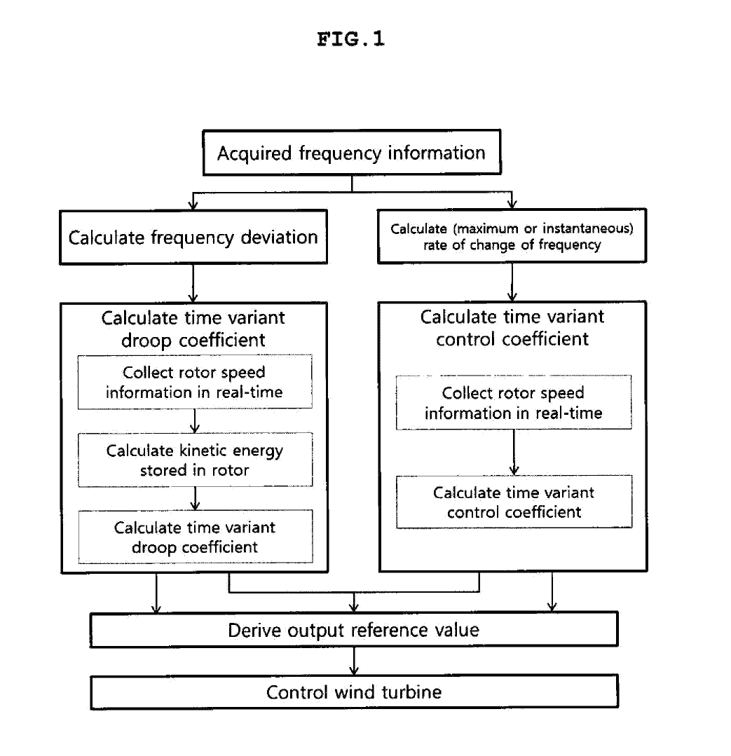

FIG. 1 is a sequence diagram illustrating an inertial control method of a wind turbine according to an embodiment of the present invention.

In this embodiment, an inertial control method of a wind turbine includes the steps of acquiring frequency information of a power grid, calculating a time variant droop coefficient when the frequency information is reduced below a preset range, and controlling the wind turbine using the calculated time variant droop coefficient, and, at this point, the step of calculating a time variant droop coefficient includes the steps of collecting rotor speed information changing according to inertial control in real-time, and calculating the time variant droop coefficient using the collected rotor speed information.

The frequency information of a power grid can be acquired through a sensor attached inside the wind turbine, a central control device for monitoring the wind turbine or the like. As is mentioned in the [Background of the Related Art] described above, if frequency of a power grid is reduced, effective power for recovering the frequency should be promptly supplied. Otherwise, generators in operation may be rejected, and, in the end, the entire power grid can be collapsed as a result. The rated frequency of an operating power grid is 60 Hz, and when frequency of the power grid is reduced below the rated frequency, it should be controlled, and, particularly, such a frequency control function is gradually requested even in a wind power plant.

When the acquired frequency information is reduced below a preset range, a time variant droop coefficient for inertial control is calculated in the present invention. The wind turbine performs the inertial control using an output reference value created through the calculated time variant droop coefficient. Describing the process of calculating the time variant droop coefficient more specifically, the step of calculating a time variant droop coefficient includes the steps of collecting rotor speed information changing according to the inertial control and calculating the time variant droop coefficient using the collected rotor speed information.

In the step of collecting rotor speed information, the rotor speed can be measured through a separate sensor provided in the wind turbine to sense a speed at which the rotor of the wind turbine rotates.

In the present invention, a time variant droop coefficient is calculated using the rotor speed information collected through the process described above. As an example of a method of calculating the time variant droop coefficient using the rotor speed information in real-time, kinetic energy of the rotor is calculated using the rotor speed information, and the time variant droop coefficient is calculated through the calculated kinetic energy of the rotor. In the present invention, the kinetic energy of the rotor is used as an important factor for determining a time variant droop coefficient needed for the inertial control. Accordingly, the kinetic energy of the rotor is calculated before the time variant droop coefficient is calculated, and this is calculated using the collected rotor speed information.

An embodiment of calculating the kinetic energy follows [Mathematical expression 1] shown below.

ΔEᵢ(t)=½j(ωᵢ(t)²−ωₘᵢₙ²) [Mathematical expression 1]

Here, ωᵢ(t) is rotor speed information according to time, and ωₘᵢₙ is the minimum operating speed of a wind turbine. J denotes a momentum of inertia.

ΔEᵢ(t) is kinetic energy of the rotor which can be released according to time. In the document 1 of the prior art described above, a droop coefficient is calculated using only the kinetic energy ΔEᵢ that can be released at the time point when a disturbance occurs, and it is used to control a wind turbine. However, in the present invention, kinetic energy of the rotor is continuously calculated not only at the time point when a disturbance occurs, but also while the inertial control is performed, and a droop coefficient is calculated based on the kinetic energy. That is, although the droop coefficient of the document 1 of the prior art is a fixed value calculated at the time point of occurring a disturbance and the wind turbine is controlled reflecting the same value all the while when the inertial control is performed, the droop coefficient of the present invention is based on kinetic energy continuously calculated (in other words, changed/updated) as the inertial control is performed, and it is a value also continuously changed while the inertial control is performed. In order to distinguish these two droop coefficients, the droop coefficient calculated as the inertial control is performed is expressed as a “time variant droop coefficient” in the present invention.

In an embodiment of the present invention, the time variant droop coefficient is calculated using kinetic energy of the rotor changing according to time. A detailed process of calculating the time variant droop coefficient is described below.

The droop coefficient is a control gain of a frequency deviation loop added to the control block for a wind turbine to perform inertial control on the wind turbine. The droop coefficient may be expressed by a droop characteristic relational expression as shown in [Mathematical expression 2].

$$\frac{Δ \overline{ {P}_{i}}}{\overline{{f}_{sys}} - \overline{{f}_{non}}} = - \frac{1}{{R}_{i}} \qquad [ Mathematical expression 2 ]$$

Here, ΔPᵢ denotes an effective amount of power added for frequency control, f_{sys} denotes an actual frequency of a power grid, and fₙₒₘ denotes a rated frequency of the power grid.

The unit of left hand side of [Mathematical expression 2] is the same with that of energy. The kinetic energy of the rotor of the wind turbine is eventually inversely proportional to the droop coefficient. In other words, a product of the kinetic energy of the rotor and the droop coefficient is constant. This can be expressed as shown in [Mathematical expression 3].

Δ E̅ᵢ̅Rᵢ=−1 [Mathematical expression 3]

If [Mathematical expression 3] is rewritten from the viewpoint of a specific wind turbine, it is as shown in [Mathematical expression 4].

Δ E̅ᵢ̅Rᵢ=Δ E̅ₘ̅ₐ̅ₓ̅R₀ [Mathematical expression 4]

Here, ΔEₘₐₓ denotes maximum kinetic energy that can be released from the rotor, which is a value corresponding to a wind turbine rotating at the maximum operating speed, and R₀ is a droop coefficient at that time. Although a wind turbine possessing ΔEₘₐₓ can be determined for a variety of reasons, in an embodiment of the present invention, it can be determined according to a maximum operating speed of the wind turbine. More specifically, it is calculated through kinetic energy released when the wind turbine reduces speed from the maximum operating speed to the minimum operating speed. Here, the maximum operating speed is a maximum speed limit that the wind turbine should not exceed to prevent mechanical defects or damage of electrical parts. Various factors can be controlled not to exceed the speed limit, and, for example, the blade pitch of the wind turbine is controlled not to exceed the maximum operating speed.

ΔEₘₐₓ is a constant, and reference droop coefficient R₀ at that time is also a constant, and time variant droop coefficient Rᵢ(t) can be calculated based on the information. The calculation is performed as shown in [Mathematical expression 5].

$${R}_{i} ( t ) = {R}_{0} \frac{Δ \overline{{E}_{max}}}{Δ \overline{{E}_{i} ( t )}} \qquad [ Mathematical expression 5 ]$$

Inertial control of a wind turbine is performed using the time variant droop coefficient calculated according to [Mathematical expression 5].

Meanwhile, in an embodiment of the present invention, the step of calculating a time variant droop coefficient includes deriving the time variant droop coefficient so that the kinetic energy of the rotor and the energy released from the wind turbine may have a positive correlation. This means that the higher the kinetic energy of the rotor of the wind turbine is, the more it may contribute to the inertial control. According to this embodiment, frequency can be recovered from a disturbance more promptly by the inertial control.

Meanwhile, a lower limit of the time variant droop coefficient of the present invention is determined within a range so that the rotor speed is not reduced below the minimum operating speed. If the time variant droop coefficient is determined in this method, the time variant droop coefficient is getting larger and reduction of speed of the wind turbine is prevented as the rotor speed approaches closer to the minimum operating speed, and the second frequency dip can be prevented since rotor speed of all wind turbines is maintained higher than the minimum operating speed even while the inertial control is performed.

In another embodiment of the present invention, the inertial control method of a wind turbine includes, after the step of acquiring frequency information of a power grid, the steps of collecting rotor speed information changing according to inertial control in real-time, and calculating a time variant control coefficient by reflecting a driving range of the wind turbine, and the wind turbine control step may include controlling the wind turbine using the calculated time variant droop coefficient and the time variant control coefficient.

Here, the time variant control coefficient is a control gain of a loop of calculating a rate of change of frequency (ROCOF) of the power grid, which is a loop added for inertial control of the wind turbine, and, in the present invention, the “time variant control coefficient” is calculated by updating the control gain in real-time using the rotor speed information, and the wind turbine is controlled reflecting the time variant control coefficient.

As an example of calculating the time variant control coefficient, minimum value and maximum value of the time variant control coefficient are derived, and the time variant control coefficient is calculated to be proportional to the rotor speed within this range. The minimum value of the time variant control coefficient can be obtained using [Mathematical expression 6],

$$\begin{matrix}\frac{d Δ \overline{E}}{d t} = Δ \overline{P} \\ = - 2 H {\overline{ω}}_{sys} \frac{d {\overline{ω}}_{sys}}{d t} \\ = {K}_{min} \overline{{f}_{sys}} \frac{d \overline{{f}_{sys}}}{d t}\end{matrix} \qquad [ Mathematical expression 6 ]$$

Here, ΔE and ΔP denote deviation of kinetic energy and deviation of effective power of the wind turbine, H denotes an inertia time constant, ω_{sys} and f_{sys} respectively denote an angular frequency and a frequency of the system. The minimum value of the time variant control coefficient calculated according to [Mathematical expression 6] is as shown in [Mathematical expression 7].

Kₘᵢₙ=2H [Mathematical expression 7]

Meanwhile, the maximum value of the time variant control coefficient can be calculated as shown in [Mathematical expression 8] using the driving range and the kinetic energy of the wind turbine.

$${K}_{max} = {K}_{min} \frac{\overline{{E}_{max}}}{\overline{{E}_{min}}} = 2 H \frac{{\overline{ω}}_{max}^{2}}{{\overline{ω}}_{min}^{2}} \qquad [ Mathematical expression 8 ]$$

Here, Eₘₐₓ and Eₘᵢₙ respectively denote kinetic energy stored in the rotor when the wind turbine operates at the maximum operating speed ωₘₐₓ and the minimum operating speed ωₘᵢₙ. In the case of a general doubly-fed induction generator (DFIG), if the driving range is assumed to be between 0.7 pu and 1.25 pu, the maximum time variant control coefficient is 6.38H.

Within the range between the maximum value and the minimum value of the time variant control coefficient calculated as described above, the time variant control coefficient is calculated in proportion to the rotor speed. The time variant control coefficient is continuously updated while the inertial control is performed according to the rotor speed information collected in real-time.

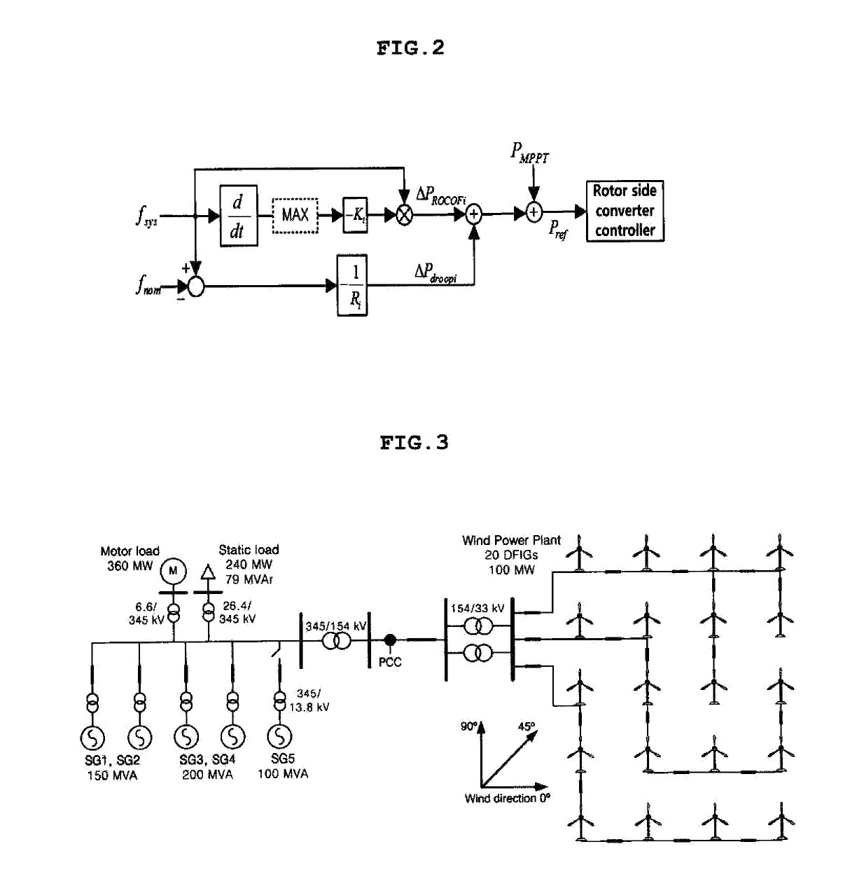

FIG. 2 is a view showing the inertial control method according to an embodiment shown in FIG. 1 in the form of a control loop. A loop using a time variant droop coefficient Rᵢ(t) is shown in a lower portion of FIG. 2. Deviation of frequency is obtained from a difference between collected frequency information of the power grid and a rated frequency, and an output reference value is created by multiplying the deviation of frequency and the time variant droop coefficient. A loop using a time variant droop coefficient Kᵢ(t) of the ROCOF loop is shown in an upper portion of FIG. 2. The rate of change of frequency is obtained from the collected frequency information of the power grid, and an output reference value is created by multiplying the rate of change of frequency and the time variant control coefficient.

In another embodiment of the present invention, the inertial control method may further include, after the step of acquiring frequency information of a power grid, the steps of: calculating a rate of change of frequency, deriving a maximum value of the rate of change of frequency, and creating an output reference value by multiplying the derived maximum value of the rate of change of frequency and the time variant control coefficient, and the wind turbine control step may include controlling the wind turbine according to the created output reference value. This is shown in FIG. 2 through the Max loop drawn as a dotted line.

In another embodiment of the present invention, the inertial control method may further include, after the step of acquiring frequency information of a power grid, the steps of: calculating a rate of change of frequency, and deriving a maximum value of the rate of change of frequency, and the wind turbine control step may include controlling the wind turbine using the calculated time variant droop coefficient and time variant control coefficient while the maximum value of the rate of change of frequency is maintained.

FIG. 3 is a mimetic view showing a model of a wind power plant for simulating an embodiment of the present invention.

In FIG. 3, a total of twenty 5 MW DFIG wind turbines are connected to a system, and total capacity of the power plant facility is 900 MVA. The amount consumed at the load is 600 MW, and a simulation is progressed assuming that SG 5 generating 70 MW is rejected while the system operates.

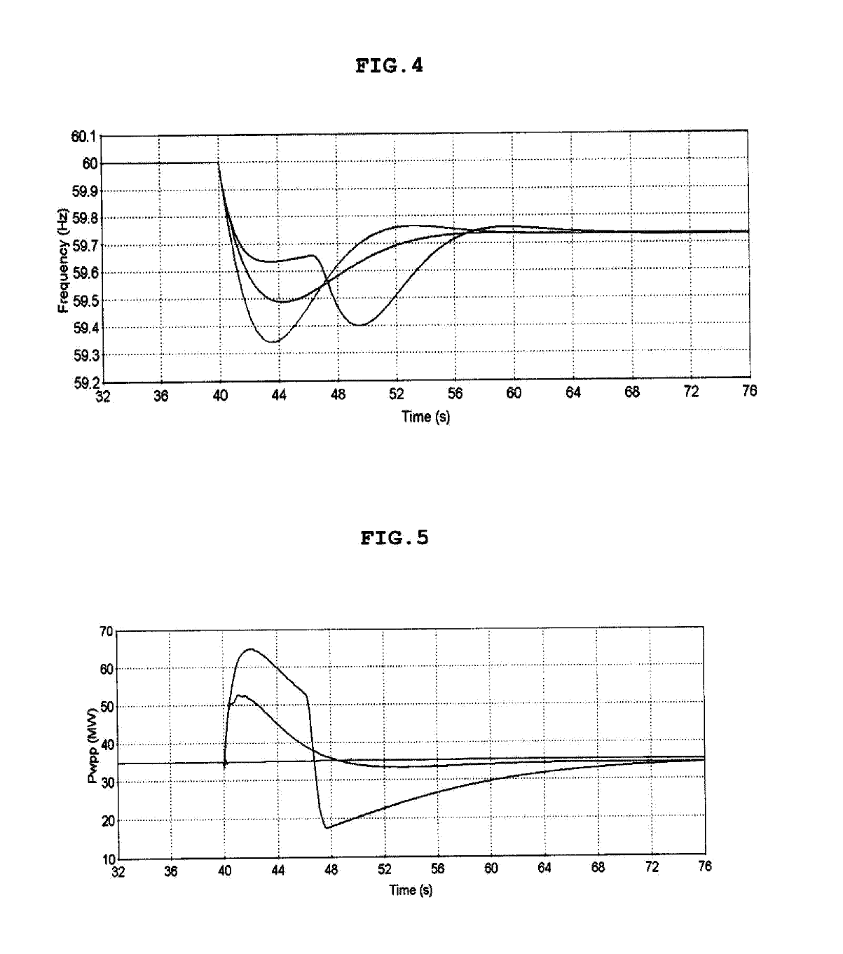

FIGS. 4 to 8 are graphs showing results of simulations according to the prior art and embodiments of the present invention in the situation presented in FIG. 3. Here, an embodiment of the present invention is a result of a simulation performed on the embodiment shown in FIG. 2. That is, it is a result of using both the time variant droop coefficient and the time variant control coefficient of the ROCOF loop. In addition, the present invention further includes a case of using only the time variant droop coefficient and a case of applying the calculated time variant control coefficient of the ROCOF loop to a loop for calculating the time variant droop coefficient and maximum rate of change of frequency.

FIG. 4 is graphs showing a system frequency according to time. The blue solid line shows a frequency according to a method of the prior art, and the red solid line shows a result of a case of applying the inertial control method according to an embodiment of the present invention. In addition, the green solid line shows a result of a power grid in which the inertial control is not applied.

Comparing lowest values of frequency (lowest frequency points) when the first frequency dip occurs, the lowest frequency point of a case of controlling a wind turbine using the inertial control method proposed in the present invention is 59.488 Hz, whereas the lowest frequency point according to a method of the prior art is 59.634 Hz. The method according to the prior art remarkably increases the lowest frequency point in the initial stage of frequency reduction, i.e., when the first frequency dip occurs, by excessively controlling the wind turbine to prevent reduction of frequency. However, the wind turbines stop the inertial control at the time point of 46 seconds due to the control which does not consider the limit of the inertial control capability of the wind turbines. Abrupt change of control mode of a wind power plant gives an influence to the entire power grid and causes the second frequency dip. According to this, the lowest frequency point becomes 59.399 Hz, which is further severe compared with that of the first frequency dip. Although this frequency point is higher than 59.340 Hz, which is the lowest frequency point of a power grid which does not apply inertial control, it shows a problem of a wind power plant which does not consider the limit of inertial control capability. On the other hand, when the present invention is applied, the lowest frequency point is effectively increased at the first dip, and, in addition, since inertial control of all the wind turbines is not stopped due to a control considering the limit of inertial control capability, the second dip does not occur. The second frequency dip is an important factor that should be confirmed when the inertial control of a wind power plant is performed since a degree of the reduction increases in proportion to the number of wind turbines which stop the inertial control, and the present invention may prevent such a second dip.

FIG. 5 shows output power of a wind power plant according to time. The blue solid line shows output power according to a method of the prior art, and the red solid line is a result of a case of applying the inertial control method according to an embodiment of the present invention. The green solid line shows a result of a case in which the inertial control is not performed.

Referring to FIG. 5, when a wind power plant is controlled according to the present invention, output power at the time point of occurring a disturbance is not so high compared with that of a method of the prior art. It is since that if output power is higher than this, the limit of the wind turbine can be exceeded considering the limit of inertial control capability. This can be confirmed through an output waveform of the method of the prior art. In the case of the method of the prior art, the lowest frequency point is increased due to remarkable increase of output power in the initial stage of the disturbance. However, wind turbines will reach the minimum operating speed before the frequency of the power grid reaches a steady state, and the inertial control is stopped at the time point of 46 seconds. This will lead to abrupt decrease of output power and gives a bad influence to the power grid, and a second frequency dip is extremely severe compared with the first frequency dip. Meanwhile, in the present invention, since a control coefficient changing according to time is used, the second frequency dip can be prevented without reaching the control limit point.

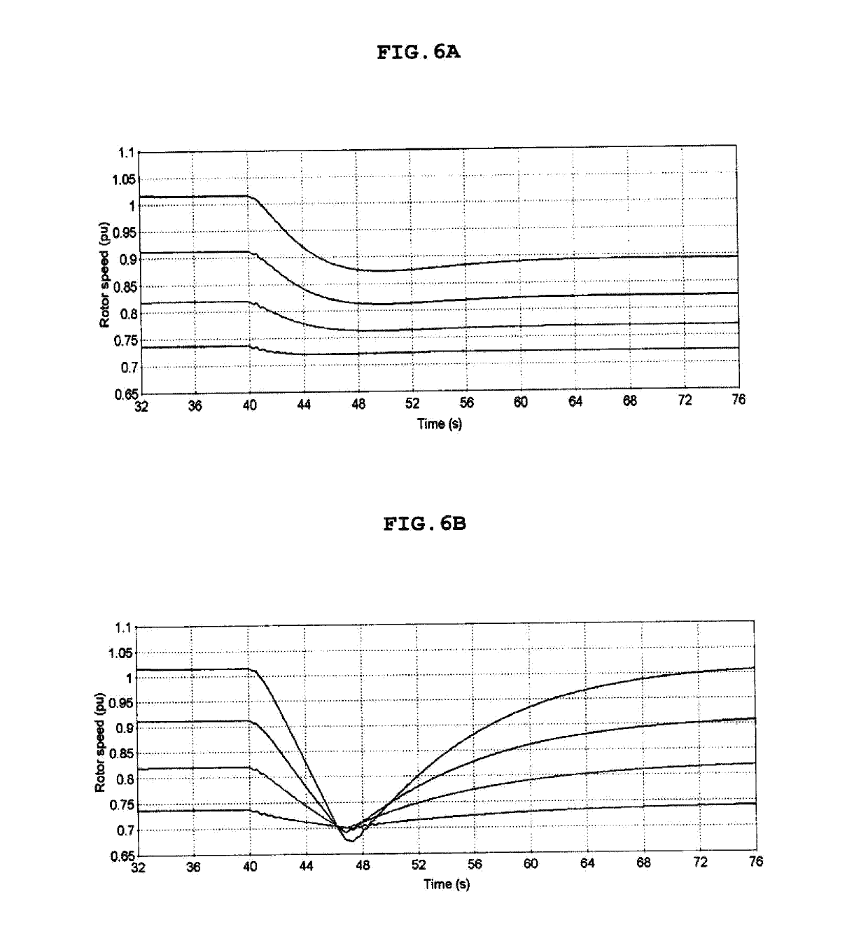

FIGS. 6A and 6B are graphs showing rotor speed of a wind turbine according to time. The graph of FIG. 6A shows rotor speed when the present invention is applied, and the graph of FIG. 6B shows rotor speed according to a method of the prior art. The red, blue, green and pink solid lines respectively show rotor speed of wind turbines placed at the first, second, third and fourth columns in a wind power plant. Since input wind speed of generators placed in the front column is higher due to a wake effect, there is a difference in the initial rotor speed. When the present invention is applied, rotor speeds of all the wind turbines converge at a point higher than 0.7 pu although the inertial control is performed. It is since that control coefficients are calculated to reduce increase of output power as the rotor speed is reduced. However, when a method of the prior art is applied, since all the wind turbines perform a control exceeding the limit of control capability, the rotor speed is reduced below 0.7 pu. At this point, the wind turbine should stop all the controls and switch to a control of increasing the speed of the wind turbine. Accordingly, the inertial control is automatically stopped, and the wind turbine increases the speed of the rotor by abruptly decreasing output power.

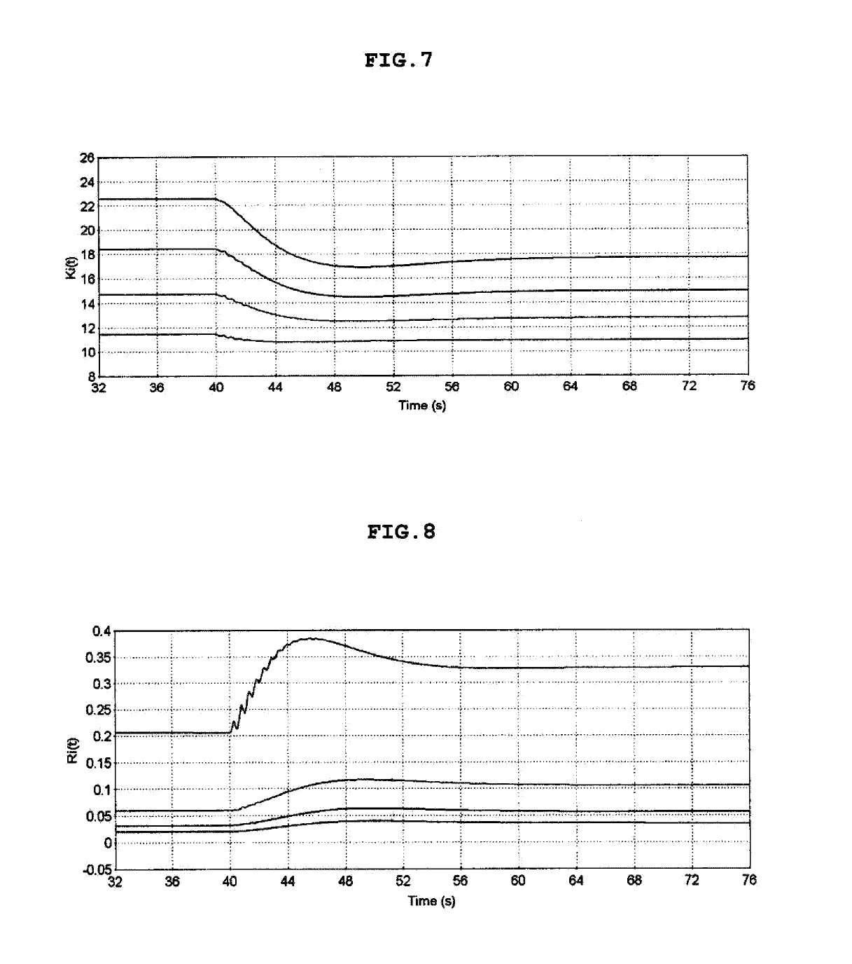

FIG. 7 is a graph showing time variant droop coefficients of wind turbines according to time, and FIG. 8 shows time variant control coefficients of a ROCOF loop. In the two graphs, the red, blue, green and pink solid lines respectively show time variant droop coefficients of wind turbines placed at the first, second, third and fourth columns in a wind power plant. Rotor speeds of the wind turbines placed in the front column increase due to a wake effect, and, accordingly, the time variant droop coefficient is calculated to be a smaller value, and the time variant control coefficient of ROCOF is calculated to be a larger value. Meanwhile, it may be confirmed such that two control coefficients are updated by reflecting the rotor speed reduced as the inertial control is progressed. In an embodiment of the present invention, a degree of increase of the time variant droop coefficient is inversely proportional to the amount of kinetic energy that can be released and, in the end, inversely proportional to the square of current rotor speed. Accordingly, a rate of increasing the time variant droop coefficient is relatively high (between 40 to 48 seconds) as the rotor speed approaches the minimum speed, and output power of the wind turbine is reduced according to time as the time variant droop coefficient increases. As a result, even a wind turbine of a low rotor speed may continue the inertial control. In addition, deviation of the time variant control coefficient of the ROCOF loop is high in a wind turbine operating at a high operating speed. The time variant control coefficients become smaller as the rotor speed is reduced, and, accordingly, all the wind turbines may continue the inertial control without being stopped.

Whether or not the inertial control can be continuously performed gives an influence to the output power of the wind power plant in the end. This can be confirmed through FIGS. 4 and 5. First, referring to FIG. 4 again, it may be confirmed that the frequency is abruptly reduced at the time point of 46 seconds in a method of the prior art. That is, since all wind turbines may not continue the inertial control, the frequency becomes unstable. This will act as a factor inducing the second frequency dip in the end. On the other hand, referring to FIG. 5, it may be confirmed that the output power is shaken at the time point of 46 seconds in a method of the prior art. That is, as the wind turbine is unable to perform the inertial control, output of the wind power plant is influenced thereby.

According to the present invention, frequency can be rapidly recovered by increasing effective power of a wind power plant when a disturbance occurs, and it may continuously contribute to frequency control without stopping inertial control by preventing the rotor speed of all the wind turbines from being reduced below the minimum operating speed.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. An inertial control method of a wind turbine, the method comprising the steps of:
acquiring frequency information of a power grid;
calculating a time variant droop coefficient when the frequency information is reduced below a preset range; and
controlling the wind turbine using the calculated time variant droop coefficient,
wherein the step of calculating a time variant droop coefficient includes the steps of:
collecting rotor speed information in real time which is changing according to the inertial control; and
calculating the time variant droop coefficient using the collected rotor speed information.

2. The method according to claim 1, wherein the step of calculating a time variant droop coefficient includes the steps of:
calculating kinetic energy of a rotor using the rotor speed information; and
calculating the time variant droop coefficient by comparing the calculated kinetic energy and maximum kinetic energy of the rotor.

3. The method according to claim 2, wherein the step of calculating the time variant droop coefficient is characterized in that deriving the time variant droop coefficient which makes the kinetic energy of the rotor and the energy released from the wind turbine have a positive correlation.

4. The method according to claim 3, wherein a lower limit of the time variant droop coefficient is determined within a range that the rotor speed is not reduced below the minimum operating speed.

5. The method according to claim 2, wherein the step of calculating kinetic energy is performed according to
ΔEᵢ(t)=½J(ωᵢ(t)²−ωₘᵢₙ²)
where ωᵢ(t) is rotor speed information according to time, ωₘᵢₙ is minimum operating speed of a wind turbine, and J is a momentum of inertia.

6. The method according to claim 2, wherein the step of calculating the time variant droop coefficient is performed according to
$${R}_{i} ( t ) = {R}_{0} \frac{Δ \overline{{E}_{max}}}{Δ \overline{{E}_{i} ( t )}}$$
where ΔEₘₐₓ is maximum kinetic energy, R₀ is a droop coefficient at the maximum kinetic energy, and ΔEᵢ(t) is kinetic energy according to time.

7. The method according to claim 1, further comprising, after the step of acquiring frequency information of a power grid, the steps of:
collecting rotor speed information in real time which is changing according to the inertial control; and
calculating a time variant control coefficient proportional to the rotor speed by reflecting a driving range of the wind turbine,
wherein the wind turbine control step includes controlling the wind turbine using the calculated time variant droop coefficient and the time variant control coefficient.

8. The method according to claim 7, further comprising, after the step of acquiring frequency information of a power grid, the steps of:
calculating a rate of change of frequency; and
deriving maximum value of the rate of change of frequency,
wherein the wind turbine control step includes controlling the wind turbine using the calculated time variant droop coefficient and time variant control coefficient while the maximum value of the rate of change of frequency is maintained.

9. An inertial control method of a wind turbine, the method comprising the steps of:
acquiring frequency information of a power grid;
collecting rotor speed information which is changing according to the inertial control in real-time; and
calculating a time variant control coefficient proportional to the rotor speed by reflecting a driving range of the wind turbine,
and further comprising, after the step of acquiring frequency information of a power grid, the steps of:
calculating a rate of change of frequency;
deriving maximum value of the rate of change of frequency; and
creating an output reference value by multiplying the derived maximum value of the rate of change of frequency and the time variant control coefficient,
wherein the wind turbine is controlled according to the created output reference value.
